(19) United States
(12) Patent Application Publication
(10) Pub. No.: US 2012/0237397 A1
(43) Pub. Date: Sep. 20, 2012

(54) CONFIGURATION AND OPERATING MODE OF AN AUTOMATED ANALYZER

(76) Inventor: Roland Schenk, Kirchheim (DE)

(21) Appl. No.: 13/498,929

(22) PCT Filed: Nov. 11, 2010
(86) PCT No.: PCT/EP10/67330

§ 371 Date: May 10, 2012

(30) Foreign Application Priority Data
Nov. 17, 2009 (DE) 10 2009 046 762.9

(51) Int. Cl. G01N 35/10

(52) U.S. Cl. 422/63

(57) ABSTRACT

An automated analysis apparatus having sample, reagent and process rotors, at least three pipetting devices for transferring first and second reagents and a sample, a mixing device, a measuring device, and a flushing device. The analysis apparatus operates in successive operating cycles with the process rotor rotating about its axis of rotation. Simultaneously in each operating cycle in different process containers at different positions of the process rotor a sample is transferred into a process container, the first reagent is transferred into a process container, the second reagent is transferred into a process container, the process mixture is mixed in a process container, the measurement parameter of the process mixture in a process container is measured, and at least one process container is flushed. The rotation of the process rotor is stopped at most twice per operating cycle to transfer a sample and the first and second reagents into a process container.

The present invention concerns an apparatus for the automated analysis of liquids, wherein said analysis apparatus has a sample rotor for sample containers, a reagent rotor for reagent containers and a process rotor for process containers, and at least one pipetting device for transferring liquids, a mixing device for mixing the process mixture, a measuring device for measuring a measurement parameter of the process mixture and a flushing device for flushing process containers.

In the context of increasing automation in the field of medical and veterinary medical diagnostics, apparatuses for the automated analysis of liquids, so-called analysers, are being increasingly used, which can take a reagent required for carrying out an analysis procedure from a reagent container and can combine it with a sample for carrying out the analysis procedure in a process container. For that purpose the analysers frequently have a sample rotor for sample containers, a reagent rotor for reagent containers and a process rotor for process containers, in which there are provided corresponding receiving regions for the respective containers. If two different reagents are needed in a process, then usually there are correspondingly provided two reagent rotors. The aforementioned rotors can generally be driven independently of each other by a drive device in the analyser for performing a rotary movement of the rotors.

The step of removing reagent or sample and transferring it into a process container is usually performed by an automatic pipetting device. Such an automatic pipetting device frequently includes a pipetting arm in which is arranged a pipetting needle which in turn in connected to a pump unit with which a liquid can be drawn up into the pipetting needle and can be ejected therefrom again. Such a pipetting arm is generally of such a design configuration that the pipetting needle can be moved with the pipetting arm over a working region, in which the reagent containers, sample containers and/or process containers are temporarily provided by the corresponding rotor.

Furthermore analysers can also include a measuring device for determining a physical or chemical parameter (process parameter) of a process mixture in a process container. The process container can be for example a cuvette which can be at least temporarily introduced into the beam path of a photometer arranged in the analyser.

In addition analysers can include a mixing device for mixing the process mixture and a flushing device for flushing process containers as well as a control unit for controlling the movements of pipetting arms and/or rotors, as well as a data processing device for setting up and executing an analysis program and for processing and outputting a measured process parameter.

As in many fields the automated analysis of liquids such as for example blood samples also involves the endeavour to increase the efficiency of automation. Here that means that it is desirable for an analyser to have a sample throughput which is as high as possible, that is to say it can analyse as many samples as possible (such as for example blood samples) per unit of time. At the same time it is desirable that the devices take up as little space as possible in the laboratories in which they are used. That can only be achieved with difficulty in particular in relation to such analysers which are intended to perform analysis procedures in which more than one reagent is used, as a dedicated reagent rotor usually has to be employed for each reagent used. The use of a second reagent is also an impediment in terms of increasing efficiency and frequently leads to a lower sample throughput in comparison with analysis procedure in which only one reagent has to be added.

There is therefore a need for an apparatus for the automated analysis of liquids, wherein more than one reagent is to be added to the process mixture in the analysis procedure and wherein the apparatus is to be capable of analysing as many samples per unit of time as possible and in that respect is nonetheless to be of as compact a structure as possible. If possible transfer of the reagents into a given process container is to be capable of being implemented in succession and with a defined time spacing.

The object of the present invention is to provide an analysis apparatus in which more than reagent can be used for carrying out the analysis, wherein the apparatus is to be capable of analysing as many samples per unit of time as possible and in that respect is nonetheless to be of as compact a structure as possible. In particular the region in which the reagent containers and/or the sample containers are arranged and the region in which the process containers are arranged are to be as compact as possible. The aim is to mix a plurality of samples with more than one reagent in process containers in each case, in a practicable arrangement, in as little space as possible, and to be able to analyse the process mixtures resulting therefrom.

That object is attained by an automated analysis apparatus having the following components:

a) precisely three rotors, namely a sample rotor for sample containers, a reagent rotor for reagent containers and a process rotor for process containers,

b) a first pipetting device for transferring a first reagent out of the reagent containers into the process containers, a second pipetting device for transferring a second reagent out of the reagent containers into the process containers and third pipetting device for transferring the sample from the sample containers into the process containers,

c) a mixing device arranged at the process rotor for mixing the process mixture,

d) a measuring device arranged at the process rotor for measuring a measurement parameter of the process mixture, and

e) a flushing device arranged at the process rotor for flushing process containers,

wherein the analysis apparatus operates in successive operating cycles in which the process rotor is rotated about its axis of rotation, wherein the following operations are simultaneously carried out in each operating cycle in different process containers at different positions of the process rotor:
transferring a sample into a process container,
transferring the first reagent into a process container,
transferring the second reagent into a process container,
mixing the process mixture in a process container,
measuring a measurement parameter of the process mixture in a process container, and
flushing at least one process container,

wherein the rotation of the process rotor is stopped at most twice per operating cycle in order to transfer a sample and the first and second reagents into a process container.

In the analysis operation the sample containers contain the samples to be analysed. The sample containers can be arranged along a circular path of the sample rotor one after the other in suitable receiving regions.

In the analysis operation the reagent containers contain the reagents required for analysis of the samples and can also be arranged along a circular path of the reagent rotor one after the other in corresponding receiving regions. In a preferred embodiment the reagent containers are so-called twin containers having two separate chambers, wherein the one reagent is contained in the one chamber and the other reagent is contained in the other chamber. Such twin containers are described in detail in the international patent application having the publication number WO 2008/058979, the entire content of which is expressly included in the present application by that reference.

In the analysis operation the samples are brought into contact with the reagents, in the process containers, forming a process mixture. The process containers can be arranged along a circular path of the process rotor one after the other in corresponding receiving regions. The process containers are suitable for measurement of a process parameter. In a given embodiment the process containers are light-transmissive cuvettes. In that analysis apparatus the measuring device is then preferably a photometer.

The 3 rotors of the apparatus are arranged in mutually juxtaposed relationship so that the axes of rotation about which those rotors can be rotated are different from each other.

The pipetting devices preferably involve pipetting arms which are pivotable about an axis of rotation and which have a pipetting needle at the distal end of the pivotal arm, wherein the pipetting needle is connected to a pump unit with which a liquid can be drawn up into the pipetting needle and can also be ejected again therefrom. The pipetting arm can move the pipetting needle over a working region in which the reagent containers, sample containers and/or process containers are temporarily provided by the corresponding rotor.

In the course of development of the present invention it was found that, in an automated analysis in which more than one reagent is to be used, it is not necessary to use two reagent rotors for achieving the highest possible sample throughput. Instead, a very high sample throughput of up to 400 samples per hour can already be achieved with precisely three rotors, namely a sample rotor, a reagent rotor and a process rotor, if there are two pipetting devices for transferring two different reagents and if the analysis apparatus operates in successive operating cycles in which the process rotor is rotated about its axis of rotation, wherein the following operations are simultaneously performed in each operating cycle in different process containers at different positions of the process rotor:
a sample is transferred into a process container,
the first reagent is transferred into a process container,
the second reagent is introduced into a process container,
the process mixture is mixed in a process container,
the measurement parameter of the process mixture is measured in a process container, and
at least one process container is flushed,

wherein the rotation of the process rotor is stopped at most twice per operating cycle in order to transfer a sample and at least two reagents into a process container.

The statement that the above-indicated operations are performed “simultaneously” is used here to mean that all those operations are carried out during the duration of one operating cycle. In other words, all those operations are admittedly performed in a given operating cycle, but one of the operations can be begun before another and/or can be concluded before another operation so that there is only an overlap in time in the performance of the two operations. In the extreme case one of the operations can even be begun and concluded at the beginning of the operating cycle and another operation can be begun and concluded at the end of the operating cycle without a time overlap between those two operations. “Simultaneously” therefore means here in respect of time within a given period defined by an operating cycle. Preferably the duration of an operating cycle is at most 15 seconds. Still more preferably the duration of an operating cycle is <10 seconds.

The present invention enjoys the advantage that, in comparison with the state of the art, in the automated analysis of liquids using at least two different reagents, there is a saving of one reagent rotor while nonetheless an extraordinarily high sample throughput can be achieved. In particular it is provided that the apparatus can analyse up to 400 samples per unit of time in a very small space. A preferred embodiment of the invention is therefore characterised in that the analysis apparatus reaches a sample throughput of at least 400 samples per hour. The fact that it is possible in that respect to dispense with a second reagent rotor means that a great deal of space is also saved by the analysis apparatus according to the invention, in particular in the region in which the reagent containers are arranged.

Dispensing with a second reagent rotor with a simultaneous increase in the sample throughput is achieved in particular by the fact that it is possible with the apparatus according to the invention to simultaneously perform a plurality of operations in a plurality of positions of the process rotor. The precise time succession of the operations depends in particular on the requirements of the respective analysis process (for example a possible time spacing between the addition of the first and second reagents) and the size (number of process container positions) of the process rotor.

In a specific embodiment of the invention the addition of the first reagent and the addition of the second reagent is effected in a given process container at a time interval relative to each other. In an alternative thereto firstly the first reagent is put into the given process container and then the second reagent.

In an embodiment of the invention the time interval between transfer of the first reagent and transfer of the second reagent into a process container is >1 min. (preferably >3 min.).

In a further specific embodiment of the analysis apparatus according to the invention it is preferable if, during a given operating cycle, one of the two reagents is transferred into a process container at the first stop at which the rotation of the process rotor is stopped, and the other of the two reagents is transferred at the second stop. In an alternative thereto the second of the two reagents is transferred into a process container at the first stop and the first of the two reagents at the second stop.

A particularly high sample throughput can be achieved if the respective following operations are carried out in the successive operating cycles during the two stops:
First stop: flushing at least one process container, transferring a sample into a process container, transferring the second reagent into a process container, and mixing the process mixture in a process container,
Second stop: transferring the first reagent into a process container.

An even higher sample throughput can be achieved if the analysis apparatus operates with successive operating cycles which can be sub-divided into the following 4 phases:
Phase 1: flushing at least one process container, transferring a sample into a process container, transferring the second reagent into a process container, and mixing the process mixture in a process container,
Phase 2: measuring a measurement parameter of the process mixture in a process container,
Phase 3: transferring the first reagent into a process container, and
Phase 4: positioning the process rotor for the next operating cycle, wherein the process rotor is rotated about its axis of rotation during phases 2 and 4 and the process rotor is stationary only during phases 1 and 3.

In such embodiments in which a multiplicity of process containers can be fitted in the process rotor, for example more than 45, 60 or 75 process containers, the number of process container positions on the circular path of the process rotor is preferably a multiple of x, wherein x=3+n and n is a whole number of ≧0. Preferably n is in the range of 0 to 7. In special embodiments of the invention x=0, 1 or 2 (→n=3, 4 or 5).

In the aforementioned embodiments having a multiplicity of process containers the process containers are grouped in the process rotor in y sectors, wherein y=x, and wherein provided in each sector is a respective first position for the process container in which the analysis process is firstly started in that sector, and further process containers are successively arranged on the circular path in that sector, in which process containers the analysis process is successively started, wherein the analysis process is firstly started in the position of the first sector and then in the respective first position of the other sectors.

In the embodiments in which the process containers are grouped in sectors the process rotor is desirably rotated in each full operating cycle through a sector+1 process container position or 2 or more sectors+1 process container position, with the proviso that less than one full revolution is implemented per operating cycle. In the case of 3 sectors the rotation is effected for example through ⅓ of the process container positions+1 process container position or through ⅔ of the process container positions+1 process container position. In the case of 5 sectors the rotation can be through ⅕, ⅖, ⅗ or ⅘ of the process container positions+1 process container position. In that way the positions for transfer of sample and reagents, for flushing and mixing can be optimally distributed over the entire process rotor and can thus also be better reached by the pipetting arms, stirring paddles and flushing devices.

In that way it is possible with the analysis apparatus according to the invention to achieve a high sample throughput even when the process rotor is of a correspondingly larger diameter by virtue of the high number of process containers. The advantage of this special grouping of the sample containers in sectors is that the analysis process can be set in operation in the various sectors in immediate time proximity and during further implementation of the analysis protocol the process rotor has to be rotated less than if the process containers arranged in mutually juxtaposed relationship on the circular path were processed one after the other. That leads to a not inconsiderable time saving with large process rotors with a large number of process containers arranged therein.

An increase in the sample throughput can also be achieved by the individual components of the analysis apparatus being particularly advantageously arranged in relation to the process rotor. If it is assumed that transfer of the sample into a process container always takes place at a position with which there is associated a centre point angle of the process rotor of 0°, then the individual components are preferably so arranged on the process rotor that:
the first pipetting device and the second pipetting device can transfer the reagents into a process container in a region of 115° to 175°,
the mixing device can mix the reaction mixture in a process container in the range of 210° to 280°, and
the flushing device can flush process containers in the region of 30° to 100°,

wherein the specified angles are to be interpreted as centre point angles measured in the clockwise direction starting from the position at 0°.

In order in particular to save space and to achieve an elongate arrangement of small depth, which is usually to be preferred for laboratory purposes, the rotors are preferably so arranged that the connecting lines between the axes of rotation of the mutually juxtaposed rotors form an angle of at most 140° to 180°. In that way, from the point of view of the person who has to subsequently introduce samples or reagents, all rotors are readily accessible from one side of the analysis apparatus without having to reach over one of the other rotors.

The flushing station of the analysis apparatus preferably has two or more flushing positions in which process containers can be flushed. That has the advantage that process containers can be simultaneously flushed at two different positions. Particularly in the case of large process rotors with process containers grouped in sectors however that also gives the advantage that a flushing operation can be carried out in various positions, depending on the position in which the process rotor is disposed at the time. For that purpose at least 1 flushing station per 15 process container positions in the process rotor are provided for those purposes in the flushing station.

It has proven to be particularly advantageous if, in the embodiments in which the flushing station has a plurality of flushing positions, those flushing positions are arranged at a suitable spacing relative to each other. In the embodiments in which the number of process containers in the process rotor is a multiple of x and the process containers are grouped in the process rotor in y sectors, wherein x=y, the mutual spacing of the flushing positions is z process container positions, wherein z=x. This means that for example in the cases in which the process containers are grouped in 3 sectors, for all 3 process container positions there is provided a flushing position in the flushing station, that is to say for example in the positions 1, 4, 7 . . . etc.

Particularly preferably the analysis apparatus has a mixing station including at least two mixing devices which can simultaneously mix the process mixture in two different process containers arranged in the process rotor. It has been found that, in some embodiments, it is particularly advantageous if the spacing between the process container positions in which the at least two mixing devices can simultaneously mix the process mixture in process containers is >3.

In a specific embodiment of the invention pre-dilution of the sample is effected. For that purpose a dilution liquid is introduced by one of the pipetting devices into an empty process container (dilution container). The original sample is then later transferred into that dilution container and the sample and the dilution liquid are mixed and the diluted sample is drawn up by the pipetting device. In the following operating cycle the diluted sample is then transferred into a process container for further implementation of the analysis process.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features is dispensed with here only for the sake of brevity and readability of the description.

Further features or groups of features and examples of possible conceivable combinations of features are disclosed or illustrated by means of the description hereinafter of the accompanying Figures in which:

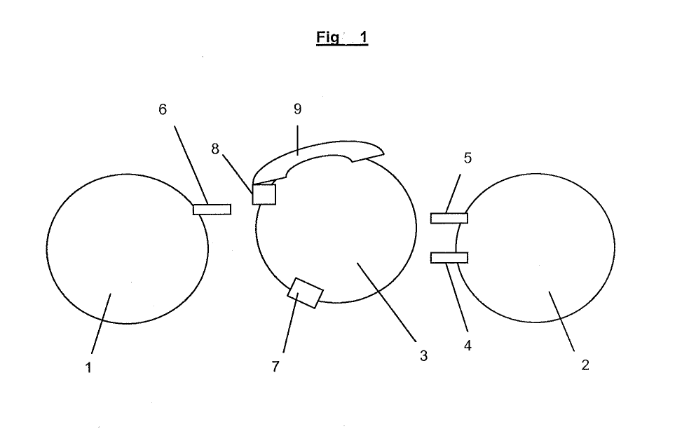

FIG. 1 shows a diagrammatic view of an embodiment of the automated analysis apparatus according to the invention, and

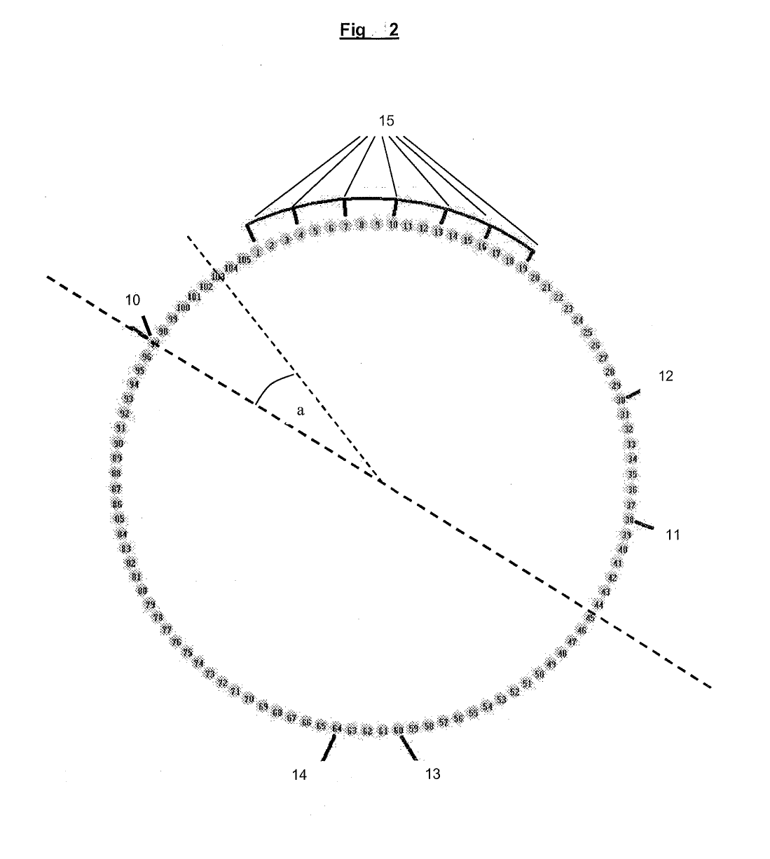

FIG. 2 shows a diagrammatic view of the process container positions in the process rotor in an embodiment of the automated analysis apparatus according to the invention.

FIG. 1 diagrammatically shows an embodiment of the automated analysis apparatus according to the invention. The analysis apparatus has precisely three rotors, namely a sample rotor 1 for sample containers, a reagent rotor 2 for reagent containers and a process rotor 3 for process containers.

Provided between the sample rotor 1 and the process rotor 3 is a pipetting device 6 for transferring the sample from the sample containers into the process containers. In this embodiment this involves a pipetting arm 6 which is rotatable about an axis of rotation and whose distal end, at which a pipetting needle is arranged on the pipetting arm 6 is shown in the view in FIG. 1 in the position in which a sample can be received from a sample container in the sample rotor 1. To transfer the received sample into a process container in the process rotor 3 the pipetting arm 6 can be pivoted towards the right so that its distal end with the pipetting needle arranged there is in a position in which the sample can be transferred into a process container.

Two further pipetting devices 4, 5 are provided between the reagent rotor 2 and the process rotor 3 in order to transfer reagents out of the reagent containers arranged in the reagent rotor 2 into process containers in the process rotor 3. In the embodiment illustrated here those two pipetting devices are also each in the form of a pipetting arm 4, 5 which is rotatable about axis of rotation and which has a pipetting needle at its distal end. In the FIG. 1 view both pipetting arms 4, 5 are in the position in which reagents can be received from reagent containers in the reagent rotor 2. To transfer the received reagents into a process container in the process rotor 3 the two pipetting arms 4, 5 can be pivoted towards the right so that their distal end with the pipetting needle arranged there is in a position in which the reagents can be transferred into a process container.

In addition the analysis apparatus has a mixing device 7 arranged on the process rotor for mixing the process mixture. The mixing device includes a drive device which can set two mixing paddles in movement. The mixing paddles are so arranged that they can dip at a spacing from each other into two different process containers in order simultaneously to mix the process mixture in those containers.

In the analysis apparatus shown here the measuring device 8 arranged on the process rotor for measuring a measurement parameter of the process mixture is a photometer. Accordingly the process containers used in this embodiment are in the form of cuvettes. In the present case the photometer 8 is arranged directly beside the flushing device 9. The position of the photometer 8 however can be basically freely selected over the entire periphery of the process rotor as photometric measurement in accordance with the present invention is effected “on the fly”, that is to say while the process rotor is rotating.

In addition also arranged on the process rotor 3 is a flushing device 9 for flushing process containers. That flushing device 9 preferably has a plurality of flushing positions for simultaneously flushing a plurality of process containers or cuvettes. An example of a possible arrangement of a plurality of flushing positions in such an apparatus is shown in FIG. 2.

In the diagrammatic view in FIG. 2 the process container positions in the process rotor are shown in a given embodiment of the automated analysis apparatus according to the invention, wherein that specific association of the various positions is preferred in particular in the case of a process rotor having 105 process container positions.

Starting from the extreme left flushing position 15 in the flushing device the various process container positions are consecutively numbered. The process container which is in the extreme left flushing position 15 in the flushing device is thus in the process container position 1. The spacing between the various flushing positions is always 2 process container positions so that in each third position there is a flushing position (here positions 1, 4, 7, 10, 13, 16 and 19).

In the process container position 30 (reference 12), with the process rotor in that position, that is the position for transfer of the second reagent into the process container which is in that position then. In the process container position 38 (reference 11), with the process rotor in that position, that is the position for transfer of the first reagent into the process container which is in that position then.

In the process container positions 60 and 64 (references 13 and 14), with the process rotor in that position, that is the position for transfer of the second reagent into the process container which is just in that position.

In the process container position 97 (reference 10), with the process rotor in that position, that is the position for transfer of the sample into the process container which is just in that position. The notional axis which defines the starting line for measurement of centre point angles a in the processor rotor (see above) also extends through that position.

Example of a particularly preferred mode of operation of a special embodiment of the analysis apparatus according to the invention:

The following description of an example for a particularly preferred mode of operation of a specific embodiment of the analysis apparatus according to the invention relates to an embodiment having a process container rotor which has 105 process containers with the process container positions, as are shown in FIG. 2.

The number of process containers in the process rotor is thus a multiple of 3 and the process containers in the process rotor are grouped in 3 sectors, wherein provided in each sector respectively is a first position for the process container in which the analysis process is first started in that sector, and arranged successively on the circular path in that sector are further process containers in which the analysis process is successively started, wherein the analysis process is started first in the first position of the first sector and then in the respective first position of the other sectors.

The operating method in accordance with which the analysis apparatus operates comprises a plurality of successive operating cycles. Those operating cycles each last only 9 seconds and consist of a total of 4 phases during which the rotation of the processor rotor for each operating cycle is stopped only twice in total. More specifically the following operations are carried out in the individual phases of each operating cycle:
Phase 1: flushing or drying of the process containers in positions 1 and 4 (drying) and 7, 10, 13, 16 and 19 (flushing), transferring a sample into the process container in position 97, transferring the second reagent into the process container in position 30, mixing the process mixture in the process containers in the positions 60 and 64,
Phase 2: measuring a measurement parameter of the process mixture in a process container,
Phase 3: transferring the first reagent into the process container in position 38, and
Phase 4: positioning the process rotor for the next operating cycle.

In the above-described method the process rotor is rotated about its axis of rotation only during phases 2 and 4 and the process rotor is stationary in phases 1 and 3.

In each full operating cycle the process rotor is rotated through 71 positions (˜243°. That corresponds to ⅔ of the total process container positions+1 process container position. In that way the positions for the transfer of sample and reagents, for flushing and mixing, are optimally distributed over the entire process rotor and can thus be better attained by the pipetting arms, stirring paddles and flushing devices.

As the process rotor is rotated through about 243° in each operating cycle the process rotor is rotated every 2 operating cycles, that is to say every 18 seconds, at least once completely around its axis of rotation. Therefore the position of the photometer on the process rotor can also be selected as desired. For, each process container in the process rotor is moved past the position of the photometer once at the latest in each second operating cycle so that then photometric measurement can be effected “on the fly”, that is to say while the respective process container in the process rotor is moving past the photometer position.

For practical reasons the photometer is preferably arranged approximately in the region opposite the flushing device, as is shown in FIG. 1.

Example for a specific embodiment of the analysis apparatus according to the invention in which pre-dilution of the sample is additionally effected during the operating cycles:

In a specific embodiment of the invention pre-dilution of the sample is effected. For that purpose a dilution liquid is introduced by the pipetting device for the first reagent into an empty process container (dilution container). 3 cycles later the first reagent is transferred by that pipetting device into an empty process container. Then, the original sample is transferred into the dilution container by the second pipetting device during phase 1, the sample and the dilution liquid are mixed and in the same cycle the diluted sample is drawn up out of the dilution container by the second pipetting device. Then in the following operating cycle the diluted sample is transferred into a process container for further implementation of the analysis process.

### LIST OF REFERENCES

1 sample rotor
2 reagent rotor
3 process rotor
4 first reagent pipetting device
5 second reagent pipetting device
6 sample pipetting device
7 mixing device
8 measuring device
9 flushing device
10 position for the transfer of a sample into a process container
11 position for the transfer of the first reagent into a process container
12 position for the transfer of the second reagent into a process container
13 first position for mixing a process mixture in a process container
13 second position for mixing a process mixture in a process container
14 positions for flushing a process container

1. An automated analysis apparatus having the following components:
a) precisely three rotors, namely a sample rotor for sample containers, a reagent rotor for reagent containers and a process rotor for process containers,
b) a first pipetting device for transferring a first reagent out of the reagent containers into the process containers, a second pipetting device for transferring a second reagent out of the reagent containers into the process containers and third pipetting device for transferring the sample from the sample containers into the process containers,
c) a mixing device arranged at the process rotor for mixing the process mixture,
d) a measuring device arranged at the process rotor for measuring a measurement parameter of the process mixture, and
e) a flushing device arranged at the process rotor for flushing process containers, wherein the analysis apparatus operates in successive operating cycles in which the process rotor is rotated about its axis of rotation, wherein the following operations are simultaneously carried out in each operating cycle in different process containers at different positions of the process rotor:
transferring a sample into a process container,
transferring the first reagent into a process container,
transferring the second reagent into a process container,
mixing the process mixture in a process container,
measuring a measurement parameter of the process mixture in a process container, and
flushing at least one process container,
wherein the rotation of the process rotor is stopped at most twice per operating cycle in order to transfer a sample and the first and second reagents into a process container.

2. The analysis apparatus according to claim 1, wherein the respective following operations are performed in the successive operating cycles during the following two stops:
First stop: flushing at least one process container, transferring a sample into a process container, transferring the second reagent into a process container, and mixing the process mixture in a process container, and
Second stop: transferring the first reagent into a process container.

3. The analysis apparatus according to claim 1, wherein the successive operating cycles are sub-divided into the following 4 phases:
Phase 1: flushing at least one process container, transferring a sample into a process container, transferring the second reagent into a process container, and mixing the process mixture in a process container,
Phase 2: measuring a measurement parameter of the process mixture in a process container,
Phase 3: transferring the first reagent into a process container, and
Phase 4: positioning the process rotor for the next operating cycle,
wherein the process rotor is rotated about its axis of rotation only during phases 2 and 4.

4. The analysis apparatus according to claim 1, wherein the number of process container positions on the circular path of the process rotor is a multiple of x, wherein x=3+n and n is a whole number of ≧0, and the process containers in the process rotor are grouped in y sectors, wherein y=x, and wherein provided in each sector is a respective first position for the process container in which the analysis process is firstly started in said sector and successively arranged on the circular path in said sector are further process containers in which the analysis process is successively started, wherein the analysis process is firstly started in the first position of the first sector and then in the respective first position of the other sectors.

5. The analysis apparatus according to claim 1, wherein the individual components of the apparatus are so arranged in relation to the process rotor that when transfer of the sample into a process container is effected in a position at a centre point angle of the process rotor of 0°:
the first pipetting device and the second pipetting device can transfer the reagents into a process container in a region of 115° to 175°,
the mixing device can mix the reaction mixture in a process container in a region of 210° to 280°, and
the flushing device can flush process containers in a region of 30° to 100°.

6. The analysis apparatus according to claim 1, wherein a flushing station has two or more flushing positions so that process containers can be flushed at two different positions.

7. The analysis apparatus according to claim 6, wherein provided in the flushing station is at least 1 flushing position per 15 process container positions in the process rotor.

8. The analysis apparatus according to claim 6, wherein in the embodiments in which the number of process containers in the process rotor is a multiple of x, wherein x=3+n and n is a whole number of 0, and the process containers are grouped in the process rotor in y sectors, wherein y=x, the spacing of the flushing positions relative to each other is z process container positions, wherein z=x.

9. The analysis apparatus according to claim 1, wherein a mixing station has at least two mixing devices for mixing the process mixture in two process containers at the same time.

10. The analysis apparatus according to claim 9, wherein spacing between the process container positions in which the at least two mixing devices can mix the process mixture in the process containers is >3.

11. The analysis apparatus according to claim 1, wherein the measuring device is a photometer.

12. The analysis apparatus according to claim 1, wherein time spacing between transfer of the first reagent and transfer of the second reagent into a process container is >1 min.

13. The analysis apparatus according to claim 1, wherein duration of an operating cycle is at most 15 s.

14. The analysis apparatus according to claim 1, wherein the analysis apparatus achieves a sample throughput of at least 400 samples per hour.
